(19) United States
(12) Patent Application Publication
(10) Pub. No.: US 2008/0290118 A1
(43) Pub. Date: Nov. 27, 2008

(54) POUR THROUGH OXIDATION SUPPRESSING STOPPER

(76) Inventors: Gregory John Luzaich, Windsor, CA (US); Michael Jeffrey Lerner, Santa Rosa, CA (US)

Correspondence Address: DERGOSITS & NOAH LLP, Suite 1450, Four Embarcadero Center, San Francisco, CA, 94111, US

(21) Appl. No.: 12/125,680

(22) Filed: May 22, 2008

Related U.S. Application Data
(60) Provisional application No. 60/931,923, filed on May 25, 2007.

(51) Int. Cl. B65B 31/02; B67D 1/04; B65D 81/20

(52) U.S. Cl. 222/152; 141/302; 141/98; 426/404

(57) ABSTRACT

A stopper for a container having a liquid, such as wine, which is subject to oxidation once opened. The stopper is provided with a neck region for fitting within a bottle and a top for residing outside of the bottle when in use. Pathways for the introduction of an inert gas, such as argon, and for air expelled from the bottle when the inert gas is introduced are selectively closeable. Liquid housed within the bottle can be poured from the stopper without removing it. Thus, an oxidizable liquid can be preserved while decanting the bottle contents at will.

### RELATED APPLICATIONS

The present application claims priority to provisional patent application Ser. No. 60/931,923 filed on May 25, 2007.

### TECHNICAL FIELD

The present invention is directed to a stopper device for the storage of an opened container of wine, such as a wine bottle whose cork has been removed and some of its contents decanted. It has been recognized that wine, particularly red wine, once opened and exposed to ambient air, oxidizes thus changing the wine's sought after characteristic taste. The present invention aides in the preservation of wine in opened containers and does so conveniently.

### BACKGROUND OF THE INVENTION

Virtually anyone who routinely drinks wine notices that if a bottle of wine is uncorked and not completely consumed, the wine contained within the bottle changes in its physical and chemical characteristics making the wine much less enjoyable to consume as time passes. This is caused by oxidation, that is, the bonding of oxygen molecules to oxidisable compounds present within the wine. Oxidation of wine results in the production of brown compounds and browning of red pigments with loss of color. It further results in the production of aldehydes and desirable grape (primary), fermentation (secondary) and aging (tertiary) derived flavors. The product of new flavor compounds can mask the desirable flavor compounds.

Such oxidisable compounds in wine include phenolics, alcohols and some flavor aldehyde compounds. Although wines suffer from oxidation, because of the high concentration of phenolics extracted from the grape skins during red wine production, red wine has a high reserve of oxidisable compounds and hence appears more sensitive to oxidative spoilage. Sulphur dioxide added to red wine loosely binds to red wine pigments decolorizing the pigment molecules and rendering a portion of the sulphur dioxide ineffective. The sulphur dioxide is also used to inhibit microbial growth and is thus a highly desirable additive for use in red wines.

It has thus been recognized to be highly desirable to limit or entirely prevent oxygen, such as that contained in ambient air, from contacting the surface of a food product, such as wine, in order to maintain the product's desirable flavor and other physical characteristics.

There have been rather rudimentary attempts to inject an inert gas in the free space of an opened wine bottle in order to displace air. There have also been syringe-like products which enable the user to withdraw air from the bottle's free space. However, such devices have proven to be ineffective in the flow of inert gas to the free space above the wine and in removal of the ambient air to substantially reduce oxidation.

In normal circumstances a wine stopper must be removed from the bottle before dispensing the wine in the bottle. When the space above the wine has been filled with an inert gas, the removal of the stopper will allow gas to escape and air to rush in to the space above the wine. Ultimately, the oxygen in the air will oxidize the wine. The best scenario would be to have a wine stopper which allows gas to be injected but does not have to be removed in order to dispense the wine.

It is thus an object of the present invention to provide a stopper, which is simple to employ, can be employed with virtually any wine bottle and which can greatly suppress oxidation of wine contained therein. Furthermore, the stopper has the added ability to dispense the wine without removing the stopper from the bottle.

This and further objects will be more readily appreciated when considering the following disclosure and appended drawings.

### SUMMARY OF THE INVENTION

The present invention is directed to a stopper device sized to fit within the neck of an opened wine bottle. The device includes a neck portion joined to a head portion, the latter extending external to the wine bottle during use. In use, pressurized inert gas introduced within the primary orifice will move through the stopper thus allowing the inert gas to be introduced within open space above the wine meniscus. The stopper has a rotary cap which essentially opens and closes the gas injection path and the fluid flow path. The primary gas injection path and the fluid flow path are selectively blocked according to the position of a plunger as part of the stopper device. In its open position, gas is allowed to be injected in to the bottle while a separate path allows air to be removed from the bottle. This separate vent air path prevents the bottle from over pressurizing during the injection of the gas. In the closed orientation, both the gas injection path and the vent fluid flow path are sealed thus isolating the contents of the bottle from external atmosphere. Because the inert gas, such as argon, is heavier than air, air will be displaced through the vent path when the gas is dispensed into the bottle via a pressurized source. Thus, by the introduction of inert gas through a primary orifice, inert gas can be conveniently, accurately and easily introduced to the free space within the wine bottle above the wine meniscus thus suppressing oxidation. Additionally, the operator can easily dispense the contents of the bottle without removing the stopper or without losing the inert gas contained within the container. Since a wine consumer would likely consume the contents of a bottle over several occasions, this will significantly reduce the overall amount of inert gas that will be needed to preserve the contents for several dispenses.

### BRIEF DESCRIPTION OF THE FIGURES

FIG. 1 is a cross-sectional view of the wine stopper of the present invention in its closed position.

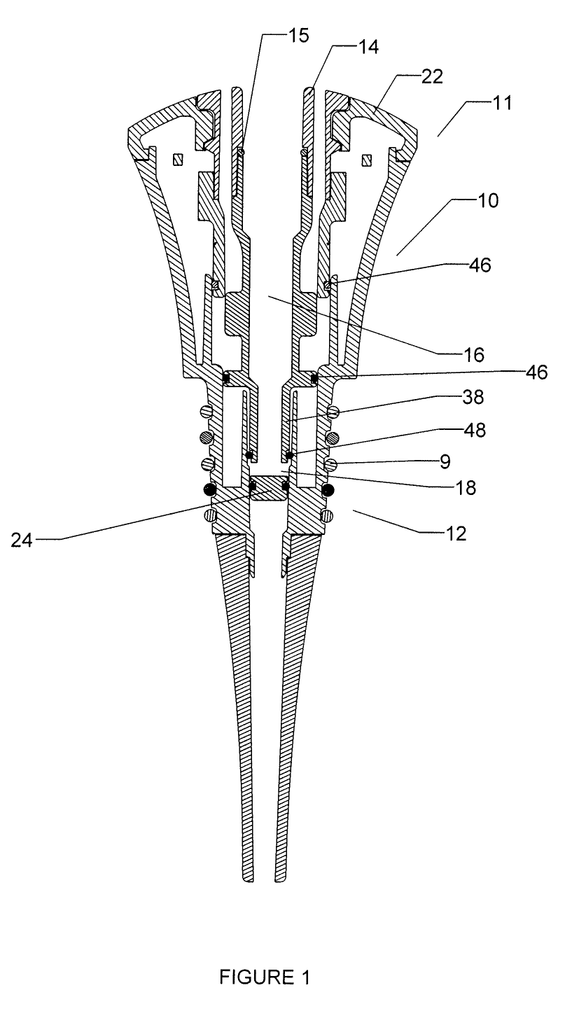

FIG. 2 is an isometric cross-sectional view of the wine stopper of the present invention in its closed position.

FIG. 3 is a cross-sectional view of the wine stopper of the present invention in the open position.

FIG. 4 is an isometric cross-sectional view of the wine stopper of the present invention in the open position.

### DETAILED DESCRIPTION OF THE INVENTION

As shown in the appended figures, the present invention involves stopper 10 having head portion 11 sized to reside eternal to a wine bottle once neck portion 12 has been inserted therein. Ideally, neck portion 12, utilizes O-rings 9 which deform as neck portion 12 is inserted within the typical neck of a wine bottle thus providing for a snug interface substantially preventing gas or liquid from entering or exiting the wine bottle interior between the neck region of the wine bottle and neck 12 of stopper 10.

In operation, any suitable, commercially available source of inert gas can be employed. Typically, such devices include a pressurized cartridge of an inert gas such as argon, having a trigger device and tube for directing the inert gas to an end point location. This tube would be inserted within the plunger 14, fitting snugly therein through the use of O-rings 15 positioned, as shown, proximate the entry port of region 11.

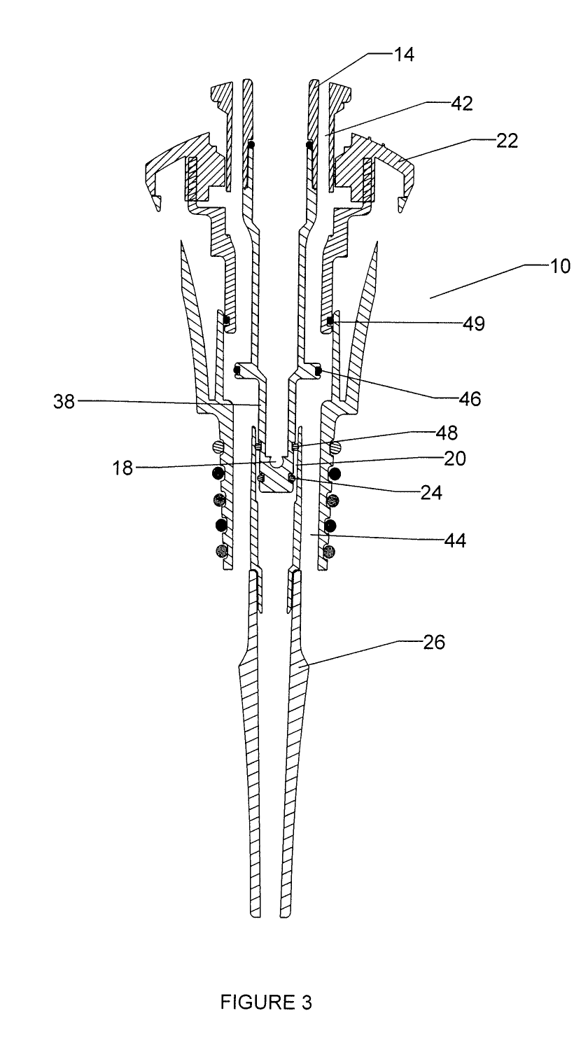

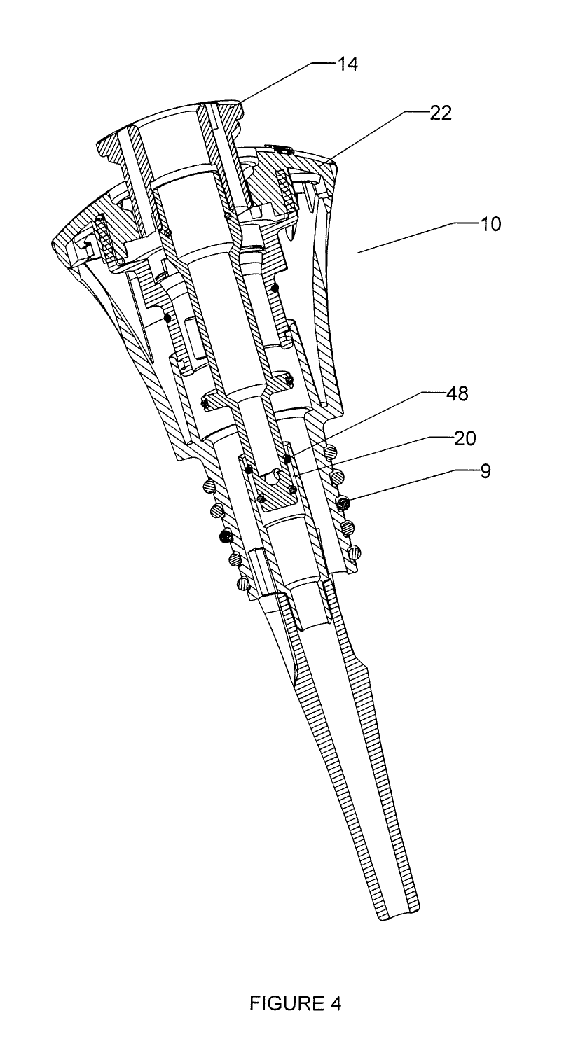

Prior to the introduction of inert gas the stopper is placed in open position (FIG. 3) by rotating cap 22 thus extending plunger 14 vertically. In this embodiment, the cap is rotated radially thus translating the plunger 14 along the axis of the plunger. The plunger may be mechanically or electromechanically translated in many different ways. During gas injection the gas travels through plunger plenum 16 and exits radially through orifice 18 into the radial area 20 between the lower plunger cap 38 and the stopper body 10. The gas passes by lower seal 24 and into bottle via the straw 26. It should be noted that when the stopper is in the open position (FIGS. 3, 4) seal 48 remains engaged with stopper body 10. This prevents gas from escaping upward during injection to the bottle.

When gas is injected a positive pressure is created inside of the container. This positive pressure causes air inside the container to be forced out first through a separate ventilation path. The ventilation path is designed such that the exiting air does not mix with the incoming inert gas. When the stopper is in the open position, positive pressure inside the container causes air to exit via vent path 44. The air continues to exit out the top of the stopper through the upper vent path 42. The plunger 14 and lower plunger cap 38 connected solid via any mechanical means. It should be noted that when the lower plunger cap 38 is in the closed position, radial seals 46, 48 and 24 seal the lower plunger cap 38 to the body 10.

By having a separate vent path, inert gas is allowed to flow through plunger 14 and lower plunger cap 38 and into the subject wine bottle thus introducing inert gas above the meniscus of the wine contained therein. The inert gas would then be caused to blanket the wine meniscus as it is heavier than air. At the same time air inside the bottle is allowed to exit the bottle via a separate vent path. This vent prevents the bottle from over pressurizing and allows the inert gas to flow in and the air to flow out.

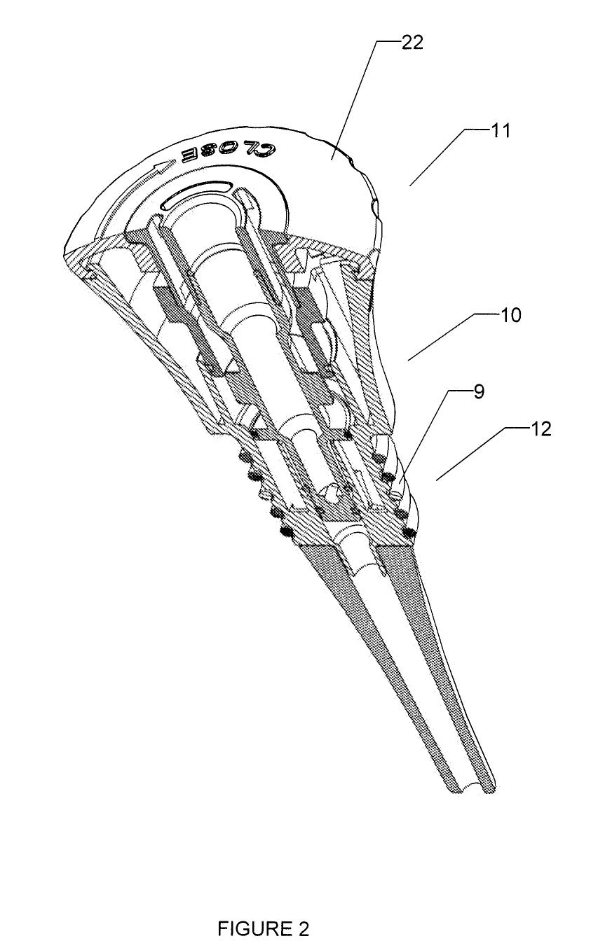

When gas injection has been completed cap 22 is rotated to its closed position. (FIG. 2.) This axially actuates the plunger 14 and lower plunger cap 38 to its lower position. Seals 46, 48 and 24 then engage with body 10. The contents of the container are now completely sealed. The bottle can be laid down and the fluid will be prevented from leaking by seals 15, 46, 48 and 24. During storage of an opened bottle with the wine stopper installed and closed, pressure can build inside the bottle due to fermentation. The seals are constructed such that they do not leak even with his added pressure.

Although the present invention was discussed in terms of the preservation of wine, it can be employed to extend the shelf life of virtually any product made the subject of oxidive deterioration. In other words, the present invention can introduce an inert gas to the interior of a container and substantially prevent the inert gas from being inadvertently dislodged there from and the product preserved thereby.

When the user wants to dispense another glass of wine the cap 22 is rotated to its open position (FIG. 4). This axially actuates the plunger 14 and lower plunger cap 38 to their upper position. Seals 46 disengages with body 10 thus opening the vent path 42 and 44. The container is now oriented for pouring and the fluid is dispensed out of the stopper via the vent path 42 and 44. It should be noted that seal 49 remains in contact with stopper body 10 at all times. It should also be noted that during dispensing, the gas injection path acts as a vent path to allow small amounts of air to enter the bottle thus preventing a vacuum from being created therein. Since the inert gas is heavier than air, the inert gas remains blanketing the wine.

Although the present invention was discussed in terms of the preservation of wine and the dispensing of the wine, it can be employed to extend the shelf life and dispense virtually any product made the subject of oxidive deterioration. In other words, the present invention can introduce an inert gas to the interior container and substantially prevent the inert gas from being inadvertently dislodged there from. The product being preserved can be any product which would otherwise suffer from oxidive deterioration. The present invention can also dispense the liquid in the container without removing the stopper and while maintaining the inert gas which has previously been injected.

1. A stopper device for a container housing a liquid, said container having an opening, a container neck region and a liquid holding region, said liquid being spaced from said opening forming a meniscus and air space at least in said container neck region, said stopper comprising a stopper neck position sized for passage through said opening and being releasably retained within said container neck region, a head portion sized to extend externally to said container when said stopper neck portion is positioned within said container neck portion, said stopper translatable between open and closed orientations such that in its open orientation, an inert gas path is established for the introduction of an inert gas above said meniscus, an air path is established for evacuating air displayed by said inert gas and a liquid dispensing path is established for decanting said liquid from said container through said stopper and when in its closed orientation, said inert gas path, air path and liquid dispensing paths are closed.

2. The stopper device of claim 1 wherein said inert gas path, air path and liquid dispensing path are selectively opened and closed by turning said head portion with respect to said stopper neck portion.

3. The stopper device of claim 2 further comprising a plunger wherein said plunger selectively extends from said stopper when said inert gas path, air path and liquid dispensing path are opened and retracts within said stopper when said inert gas path, air path and liquid dispensing path are closed.

4. The stopper device of claim 1 wherein said inert gas is heavier than air.

5. The stopper device of claim 1 wherein said inert gas is argon.

6. The stopper device of claim 3 wherein said plunger further comprises a plunger plenum through which said inert gas path is selectively established.

7. The stopper device of claim 3 wherein said inert gas path is established in a radial orifice between said plunger, stopper neck portion and head portion.

8. The stopper device of claim 1 wherein said liquid is wine.

9. The stopper device of claim 1 further comprising O-rings on said stopper neck for sealing said stopper neck to said container neck region.

10. A method for preserving a liquid in a container, said container having an opening, a container neck region and a liquid holding region, said liquid being spaced from said opening forming a meniscus and air space at least in said container neck region, inserting said stopper through said opening and into said container neck region, said stopper comprising a stopper neck portion sized for passing through said opening and being releaseably retained within said container neck region, a head portion sized to extend external to said container once its stopper neck is positioned within said container neck portion, said stopper translatable between open and closed orientations, oriented said stopper in an open orientation, injecting an inert gas through an inert gas path established within said stopper, said inert gas being introduced above said meniscus, expelling air from said air space through an air path in said stopper as a result of the introduction of said inert gas and providing a liquid dispensing path established for decanting said liquid from said container through said stopper when said stopper is in an open orientation and when in a closed orientation, closing said inert gas path, air path and liquid dispensing path.

11. The method of claim 10 whereby said head portion is turned with respect to said stopper neck portion to selectively open and close said gas path, air path and liquid dispensing path.

12. The method of claim 11 wherein turning said head portion with respect to said stopper neck portion causes a plunger to selectively extend from said stopper when said inert gas path, air path and liquid dispensing path are opened and retracts within said stopper when said inert gas path, air path and liquid dispensing path are closed.

13. The method of claim 10 wherein said inert gas is heavier than air.

14. The method of claim 10 wherein said inert gas is argon.

15. The method of claim 12 wherein said inert gas is caused to selectively pass through an inert gas path created in a plenum as part of said plunger.

16. The method of claim 12 wherein said inert gas passes through a radial orifice between said plunger, stopper neck portion and head portion.
